(19) United States
(12) Patent Application Publication
(10) Pub. No.: US 2018/0115176 A1
(43) Pub. Date: Apr. 26, 2018

(54) BATTERY POWER SUPPLY CIRCUIT

(71) Applicant: Contemporary Amperex Technology Co., Limited, Ningde (CN)

(72) Inventors: Fuming Ye, Ningde (CN); Gaosong Shen, Ningde (CN)

(21) Appl. No.: 15/794,022

(22) Filed: Oct. 26, 2017

(30) Foreign Application Priority Data
Oct. 26, 2016 (CN) 201610944455.8

(51) Int. Cl. H02J 7/00

(52) U.S. Cl. CPC H02J 7/0052; H02J 7/007; H02J 7/0068

(57) ABSTRACT

A battery power supply circuit includes: a main power circuit unit including an energy storage element and configured to control charging of the energy storage element and the battery by a constant current power supply or charging of the battery by the energy storage element; a constant current feedback circuit unit configured to detect an output current of the main power circuit unit charging the battery, compare the output current with a preset first threshold value, and output a current comparison result; a constant voltage feedback circuit unit configured to detect an output voltage of the main power circuit unit charging the battery, compare the output voltage with a preset second threshold value, and output a voltage comparison result; a control circuit unit configured to output control signals to the main power circuit unit according to the current comparison result and the voltage comparison result.

### CROSS-REFERENCE TO RELATED APPLICATION

The present application claims priority to Chinese patent application No. 201610944455.8 filed on Oct. 26, 2016, the whole disclosure of which is incorporated herein by reference.

### BACKGROUND OF THE INVENTION

### Field of the Invention

The present invention generally relates to batteries and, more particularly, relates to a battery power supply circuit.

### Description of the Related Art

Lithium-ion battery energy storage is a standby power supply for communication equipments. When the electric supply cannot be supplied for the communication equipments, the front AC/DC power supply does not work. The communication equipments need uninterrupted power supply and, therefore, the standby power supply plays a vital role in this case. However, if the electric supply cannot be supplied for a long time and the standby power supply cannot be supplemented in time, the standby power supply will also be exhausted.

In order to ensure that the battery will not be over discharged, BMS will turn off the battery output and stop external discharge until the electric supply is normal, and the AC/DC constant current power supply will charge the communication equipment and the standby power supply. If the minimum operating voltage of the communication equipment is lower than the battery voltage after feeding, the communication equipment and the battery are charged by the AC/DC constant current power supply at the same time. If the minimum operating voltage of the communication equipment is higher than the battery voltage after feeding, the battery is charged by the AC/DC constant current power supply with higher power, so that the voltage reaches the minimum operating voltage of the communication equipment to ensure the normal operation of the communication equipment after the electric supply is normal.

However, the conventional battery power supply circuit has the following disadvantages.

After the feeding of the standby power supply, the communication equipment may still cannot work properly when the electric supply is normal. Therefore, to ensure the normal operation of the communication equipment, a large power AC/DC constant current power supply is needed, or the minimum operating voltage is set lower by the communication equipment manufacturers.

### SUMMARY OF THE INVENTION

One object of the present invention is to provide a battery power supply circuit with lower power AC/DC constant current power supply.

According to one embodiment of the present invention, a battery power supply circuit includes a main power circuit unit, a constant current feedback circuit unit, a constant voltage feedback circuit unit and a control circuit unit, wherein

the main power circuit unit includes an energy storage element, and the main power circuit unit is configured to control charging of the energy storage element and the battery by the constant current power supply or charging of the battery by the energy storage element according to control signals output from the control circuit unit;

the constant current feedback circuit unit is configured to detect an output current of the main power circuit unit charging the battery, compare the output current with a preset first threshold value to obtain a current comparison result, and output the current comparison result to the control circuit unit;

the constant voltage feedback circuit unit is configured to detect an output voltage of the main power circuit unit charging the battery, compare the output voltage with a preset second threshold value to obtain a voltage comparison result, and output the voltage comparison result to the control circuit unit; and

the control circuit unit is configured to output control signals to the main power circuit unit according to the current comparison result and the voltage comparison result.

According to one aspect of the present invention, the control circuit unit is configured to:

output the control signals to the main power circuit unit so that the main power circuit unit increases frequency of charging the energy storage element and the battery by the constant current power supply until the current comparison result that the output current is greater than the first threshold value or the voltage comparison result that the output voltage is greater than the second threshold value occurs, and output the control signals to the main power circuit unit so that the main power circuit unit stops or reduces the frequency of charging the energy storage element and the battery by the constant current power supply.

According to one aspect of the present invention, the main power circuit unit includes a switching element and a freewheel diode;

one pole of the constant current power supply is connected to one pole of the battery, another pole of the constant current power supply is connected to another pole of the battery through the switching element and the energy storage element in turn, and a connection point of the switching element and the energy storage element is connected to one pole of the battery via the freewheel diode; and

an output terminal of the control circuit unit is connected to a control terminal of the switching element and the switching frequency of the switching element is controlled by the output signals of the control circuit unit.

According to one aspect of the present invention, the switching element is a field effect transistor, a gird of the field effect transistor is connected to the output terminal of the control circuit unit, and the control signal output by the control circuit unit is PWM signal duty ratio of the field effect transistor.

According to one aspect of the present invention, a positive pole of the constant current power supply in the main power circuit unit is connected to a positive pole of the battery, a negative pole of the constant current power supply is connected to a negative pole of the battery via the switching element and the energy storage element in turn, a connection point of the switching element and the energy storage element is connected to a positive pole of the freewheel diode, and a negative pole of the freewheel diode is connected to the positive pole of the battery.

According to one aspect of the present invention, the control circuit unit includes a control chip, and an enable pin of the control chip is connected to the constant current power supply, an output terminal of the control chip outputs control signals to the main power circuit unit, an input terminal of the control chip is connected to an output terminal of the constant current feedback circuit unit and an output terminal of the constant voltage feedback circuit unit respectively.

According to one aspect of the present invention, the constant current feedback circuit unit includes a first difference amplifier, a first comparator and a sense resistor connected in series between the main power circuit unit and the battery, two input terminals of the first difference amplifier are connected to two terminals of the sense resistor respectively, an output terminal of the first difference amplifier is connected to one input terminal of the first comparator, and another input terminal of the first comparator is connected to a first reference voltage, and the output terminal of the first comparator is connected to an input terminal of the control circuit unit.

According to one aspect of the present invention, the sense resistor is connected in series between the main power circuit unit and the negative pole of the battery.

According to one aspect of the present invention, the constant voltage feedback circuit unit includes a second difference amplifier and a second comparator, one input terminal of the second difference amplifier is connected to the positive pole of the battery, another input terminal of the second difference amplifier is grounded, an output terminal of the second difference amplifier is connected to an input terminal of the second comparator, another input terminal of the second comparator is connected to a second reference voltage, and an output terminal of the second comparator is connected to the input terminal of the control circuit unit.

According to one aspect of the present invention, the first threshold value and the second threshold value are set by a host computer, and the host computer is connected to the constant current feedback circuit unit and the constant voltage feedback circuit unit respectively.

Compared with the prior art, the battery power supply circuit of the present invention has the following advantages.

The current and voltage input to the battery are obtained by the constant current feedback circuit unit and the constant voltage feedback circuit unit. When the voltage difference of the output voltage of the AC/DC power supply and the battery voltage is too large and causes the battery charge current exceed the set value, the input voltage will not be dragged down by the battery via turning on the circuit constant current charging function. At the same time, when the output voltage of the AC/DC power supply is too high and causes the battery charging voltage exceed the set value, the battery input voltage will not be too high via turning on the circuit constant voltage charging function.

### BRIEF DESCRIPTION OF THE DRAWINGS

Other advantages and novel features will be drawn from the following detailed description of preferred embodiments with the attached drawings, in which:

FIG. 1 depicts a structure diagram of a battery power supply circuit according to one embodiment of the present invention;

FIG. 2 depicts a circuit schematic diagram of a battery power supply circuit according to one embodiment of the present invention; and

FIG. 3 depicts a circuit actuation flow diagram of a battery power supply circuit according to one embodiment of the present invention.

### DETAILED DESCRIPTION OF PREFERRED EMBODIMENTS

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like element throughout.

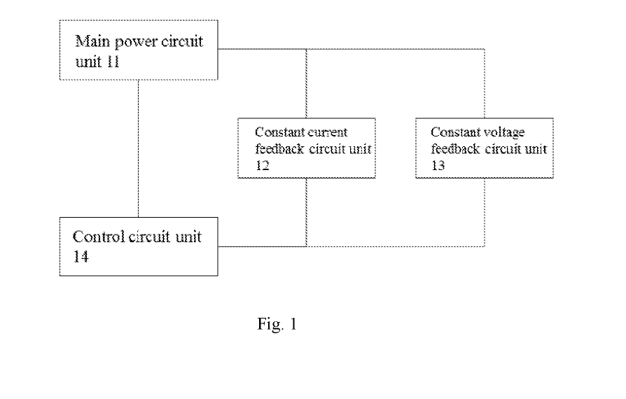

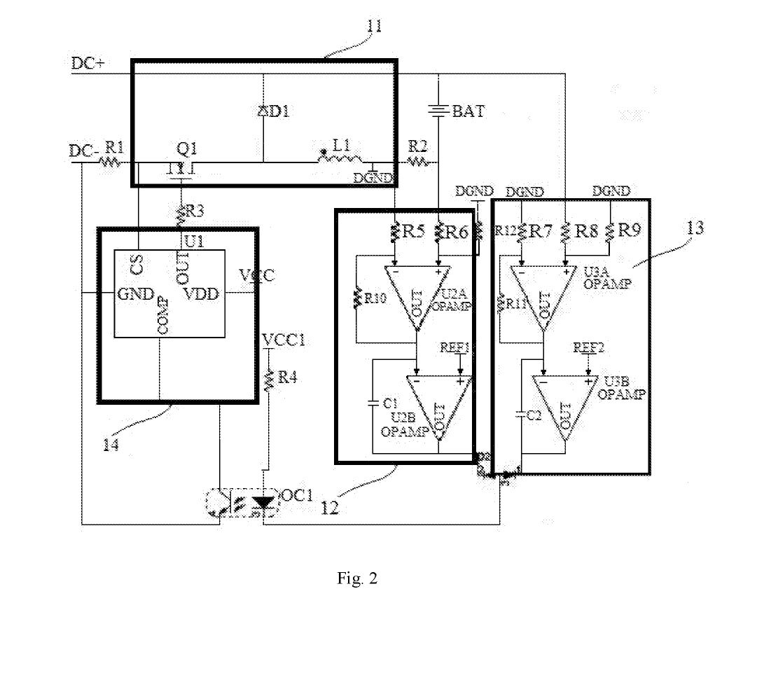

Referring to FIGS. 1 and 2, a battery power supply circuit according to one embodiment of the present invention includes a main power circuit unit 11, a constant current feedback circuit unit 12, a constant voltage feedback circuit unit 13 and a control circuit unit 14, wherein:

the main power circuit unit 11 includes an energy storage element L1, and the main power circuit unit 11 is configured to control charging of the energy storage element L1 and the battery BAT by the constant current power supply or charging of the battery BAT by the energy storage element L1, according to the control signals output from the control circuit unit 14;

the constant current feedback circuit unit 12 is configured to detect an output current of the main power circuit unit 11 charging the battery BAT, compare the output current with a preset first threshold value to obtain a current comparison result, and output the current comparison result to the control circuit unit 14;

the constant voltage feedback circuit unit 13 is configured to detect an output voltage of the main power circuit unit 11 charging the battery BAT, compare the output voltage with a preset second threshold value to obtain a voltage comparison result, and output the voltage comparison result to the control circuit unit 14; and

the control circuit unit 14 is configured to output control signals to the main power circuit unit 11 according to the current comparison result and the voltage comparison result.

Specifically, the main power circuit unit 11 is switched at a controllable switching frequency between that the energy storage element L1 and the battery BAT are charged by the constant current power supply and that the battery BAT is charged by the energy storage element L1. The control circuit unit 14 outputs control signals for controlling the switching frequency to the main power circuit unit 11 according to the current comparison result and the voltage comparison result. The frequency of which the energy storage element L1 and the battery BAT is charged by the constant current supply power is controlled by comparing the output current with the preset first threshold value and comparing the output voltage with the preset second threshold value, so that the output voltage and the output current are modulated.

The current and voltage input to the battery are obtained by the constant current feedback circuit unit 12 and the constant voltage feedback circuit unit 13. When the voltage difference of output voltage in the AC/DC power supply and the battery voltage is too large and causes the battery charge current exceed the set value, the battery power supply circuit of the present invention ensures that the input voltage will not be dragged down by the battery through turning on the circuit constant current charging function. At the same time, when the output voltage of the AC/DC power supply is too high and causes the battery charging voltage exceed the set value, the battery input voltage will not be too high through turning on the circuit constant voltage charging function.

According to one embodiment of the battery power supply circuit of the present invention, the control circuit unit 14 is configured to: output the control signals to the main power circuit unit 11 so that the main power circuit unit 11 increases the frequency of charging the energy storage element L1 and the battery BAT by the constant current power supply until the output current is greater than the first threshold value or the output voltage is greater than the second threshold value, then output the control signals to the main power circuit unit 11 so that the main power circuit unit 11 stops or reduces the frequency of charging the energy storage element L1 and the battery BAT by the constant current power supply.

Specifically, the control circuit unit 14 outputs control signals to the main power circuit unit 11 in an initial stage to increase the frequency of charging the energy storage element L1 and the battery BAT by the constant current power supply, thereby increasing the output current and the output voltage to the battery. At the same time, the constant current feedback circuit unit 12 detects the output current and the constant voltage feedback circuit unit 13 detects the output voltage. The constant current feedback circuit unit 12 or the constant voltage feedback circuit unit 13 feeds back to the control circuit unit 14 when the output current exceeds the first threshold value or the output voltage exceeds the first threshold value, so that the control circuit unit 14 outputs control signals, the main power circuit unit 11 stops or reduces the frequency for charging the energy storage element L1 and the battery BAT by the constant current power supply, and the main power circuit unit 11 outputs constant output current and constant output voltage to the battery BAT.

According to one embodiment of the battery power supply circuit of the present invention, the main power circuit unit 11 includes a switching element Q1 and a freewheel diode D1. One pole of the constant current power supply is connected to one pole of the battery BAT, the other pole of the constant current power supply is connected to the other pole of the battery BAT through the switching element Q1 and the energy storage element L1 in turn, and the connection point of the switching element Q1 and the energy storage element L1 is connected to one pole of the battery BAT through the freewheel diode D1.

The output terminal of the control circuit unit 14 is connected to the control terminal of the switching element Q1 and the switching frequency of the switching element Q1 is controlled by the output signals of the control circuit unit 14.

Specifically, the switching frequency of the switching element Q1 controls the frequency at which the switching element Q1 is turned on or turned off. When the switching element Q1 is turned on, the energy storage element L1 and the battery BAT are charged by the constant current power supply at the same time so that the energy storage element L1 stores energy. When the switching element Q1 is turned off, the battery BAT is charged by the energy storage element L1 through the freewheel diode D1.

Therefore, the output voltage and the output current of the main power circuit unit 11 can be controlled by controlling the switching frequency of the switching element Q1.

The energy storage element L1 is preferably an energy storage inductance.

According to one embodiment of the battery power supply circuit of the present invention, the switching element Q1 is a field effect transistor, preferably an insulated gate type field effect transistor (MOS transistor). The gird of the field effect transistor is connected to the output terminal of the control circuit unit 14, and the control signal output by the control circuit unit 14 is the PWM signal duty ratio of the field effect transistor.

According to one embodiment of the battery power supply circuit of the present invention, the positive pole DC+ of the constant current power supply in the main power circuit unit 11 is connected to the positive pole of the battery BAT, the negative pole DC− of the constant current power supply is connected to the negative pole of the battery BAT through the switching element Q1 and the energy storage element L1 in turn, the connection point of the switching element Q1 and the energy storage element L1 is connected to the positive pole of the freewheel diode D1, and the negative pole of the freewheel diode D1 is connected to the positive pole of the battery BAT.

In this embodiment, the switching element Q1 and the energy storage element L1 are connected in series with the negative pole of the constant current power supply, so as to avoid outputting a higher voltage to the constant current feedback circuit unit 12 and affecting the measurement accuracy.

According to one embodiment of the battery power supply circuit of the present invention, the control circuit unit 14 includes a control chip U1, and the enable pin CS of the control chip U1 is connected to the constant current power supply, the output terminal of the control chip U1 outputs control signals to the main power circuit unit 11, the input terminal CCMP of the control chip U1 is connected to the output terminal of the constant current feedback circuit unit 12 and the output terminal of the constant voltage feedback circuit unit 13, respectively.

Specifically, the enable pin of the control pin U1 is connected to the constant current power supply through a resistor R1.

The control chip U1 may be connected to the output terminal of the constant current feedback circuit unit 12 and the output terminal of the constant voltage feedback circuit unit 13 through an input terminal. For example, referring to FIG. 1, two diodes are respectively connected to the output terminals of the constant current feedback circuit unit 12 and the constant voltage feedback circuit unit 13, and then the two diodes are connected in common with the input terminal of the control circuit unit 14.

The control chip U1 may also be connected to the output terminals of the constant current feedback circuit unit 12 and the output terminal of the constant voltage feedback circuit unit 13 respectively through two input terminals. Then the output terminal of the constant current feedback circuit unit 12 and the output terminal of the constant voltage feedback circuit unit 13 are calculated in internal operation.

According to one embodiment of the battery power supply circuit of the present invention, the constant current feedback circuit unit 12 includes a first difference amplifier U2A, a first comparator U2B and a sense resistor R2 connected in series between the main power circuit unit 11 and the battery BAT. Two input terminals of the first difference amplifier U2A are connected to two terminals of the sense resistor R2 respectively, the output terminal of the first difference amplifier U2A is connected to one input terminal of the first comparator U2B, the other input terminal of the first comparator U2B is connected to a first reference voltage REF1, and the output terminal of the first comparator U2B is connected to the input terminal of the control circuit unit 14.

Specifically, the output terminal of the first comparator U2B is connected to the input terminal of the control circuit unit 14 through an optocoupler OC1 or an A/D convertor.

The sense resistor R2 converts the output current to a voltage correspondingly and then the voltage is amplified through the first difference amplifier U2A, which is compared with the first reference voltage REF1 in the first comparator U2B. The voltage of the first reference voltage REF1 is the product of the sense resistor R2 and the first threshold value.

The voltage is amplified by difference and compared with the first reference voltage REF1, and the corresponding signal is output to the control circuit unit 14 when the voltage after the output current passing through the sense resistor R2 exceeds the first reference voltage REF1.

According to one embodiment of the battery power supply circuit of the present invention, the sense resistor R2 is connected in series between the main power circuit unit 11 and the negative pole of the battery.

In this embodiment, the sense resistor R2 is connected in series between the main power circuit unit 11 and the negative pole of the battery, which can prevent the first difference amplifier U2A from failing to be operated in the linear amplification region when the output current is excessively large, thereby improving the applicable range of the battery power supply circuit of the present invention.

According to one embodiment of the battery power supply circuit of the present invention, the constant voltage feedback circuit unit 13 includes a second difference amplifier U3A and a second comparator U3B. One input terminal of the second difference amplifier U3A is connected to the positive pole of the battery, the other input terminal of the second difference amplifier U3A is grounded, the output terminal of the second comparator U3B is connected to the input terminal of the second comparator U3B, the other input terminal of the second comparator U3B is connected to a second reference voltage REF2, and the output terminal of the second comparator U3B is connected to the input terminal of the control circuit unit 14.

Specifically, the output terminal of the second comparator U3B is connected with the input terminal of the control circuit unit 14 through an optocoupler OC1 or an A/D convertor.

The output voltage is amplified through the second difference amplifier U3A and is compared with the second reference voltage REF2 in the second comparator U3B. The voltage of the second reference voltage REF2 is the second threshold value.

The voltage is amplified by difference and compared with the second reference voltage REF2, and the corresponding signal is output to the control circuit unit 14 when the output voltage exceeds the second reference voltage REF2.

According to one embodiment of the battery power supply circuit of the present invention, the first threshold value and the second threshold value are set by a host computer, and the host computer is connected to the constant current feedback circuit unit 12 and the constant voltage feedback circuit unit 13 respectively.

In this embodiment, the first threshold value and the second threshold value are controlled by the host computer, particularly by the microcontroller unit (MCU) in the host computer, so as to realize adjustable constant current control and constant voltage control.

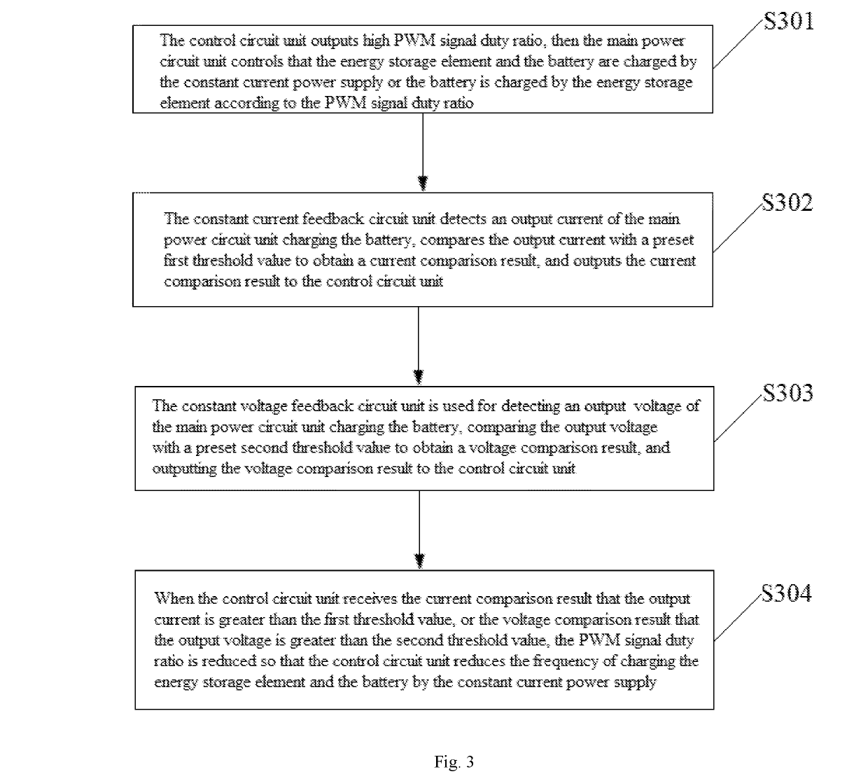

Referring to FIG. 3, the circuit actuation of the battery power supply circuit according to one embodiment of the present invention operates as follows:

Step 301, the control circuit unit 14 outputs high PWM signal duty ratio, the main power circuit unit 11 controls charging of the energy storage element L1 and the battery BAT by constant current power supply or charging the battery BAT by the energy storage element L1 according to the PWM signal duty ratio;

Step 302, the constant current feedback circuit unit 12 detects an output current of the main power circuit unit 11 charging the battery, compares the output current with a preset first threshold value to obtain a current comparison result, and outputs the current comparison result to the control circuit unit 14;

Step 303, the constant voltage feedback circuit unit 13 detects an output voltage of the main power circuit unit 11 charging the battery, compares the output voltage with a preset second threshold value to obtain a voltage comparison result, and outputs the voltage comparison result to the control circuit unit 14;

Step 304, when the control circuit unit 14 receives a current comparison result that the output current is greater than the first threshold value, or a voltage comparison result that the output voltage is greater than the second threshold value, the PWM signal duty ratio is reduced, so that the control circuit unit 14 reduces the frequency of charging the energy storage element L1 and the battery BAT by the constant current power supply.

Compared with the prior art, the battery power supply circuit according to the present invention has the following advantages.

The current and voltage input to the battery are obtained by the constant current feedback circuit unit 12 and the constant voltage feedback circuit unit 13. When the voltage difference of the output voltage in the AC/DC power supply and the battery voltage is too large and causes the battery charge current exceed the set value, the input voltage will not be dragged down by the battery through turning on the circuit constant current charging function. At the same time, when the output voltage of the AC/DC power supply is too high and causes the battery charging voltage exceeds the set value, the battery input voltage will not be too high through turning on the circuit constant voltage charging function.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions describe example embodiments, it should be appreciated that alternative embodiments without departing from the scope of the appended claims. Although specific terms are employed herein, they are used in a generic and descriptive sense only and not for purposes of limitation.

What is claimed is:

1. A battery power supply circuit, comprising: a main power circuit unit, a constant current feedback circuit unit, a constant voltage feedback circuit unit and a control circuit unit,
wherein the main power circuit unit comprises an energy storage element and is configured to control charging of the energy storage element and the battery by a constant current power supply or charging of the battery by the energy storage element according to control signal output from the control circuit unit;
the constant current feedback circuit unit is configured to detect an output current of the main power circuit unit charging the battery, compare the output current with a preset first threshold value to obtain a current comparison result, and output the current comparison result to the control circuit unit;
the constant voltage feedback circuit unit is configured to detect an output voltage of the main power circuit unit charging the battery, compare the output voltage with a preset second threshold value to obtain a voltage comparison result, and output the voltage comparison result to the control circuit unit; and
the control circuit unit is configured to output control signals to the main power circuit unit according to the current comparison result and the voltage comparison result.

2. The battery power supply circuit of claim 1, wherein the control circuit unit is configured to:
output the control signals to the main power circuit unit so that the main power circuit unit increases frequency of charging the energy storage element and the battery by the constant current power supply until the current comparison result that the output current is greater than the first threshold value or the voltage comparison result that the output voltage is greater than the second threshold value occurs, and output the control signals to the main power circuit unit so that the main power circuit unit stops or reduces the frequency of charging the energy storage element and the battery by the constant current power supply.

3. The battery power supply circuit of claim 2, wherein the main power circuit unit comprises a switching element and a freewheel diode;
one pole of the constant current power supply is connected to one pole of the battery, another pole of the constant current power supply is connected to another pole of the battery through the switching element and the energy storage element in turn, and a connection point of the switching element and the energy storage element is connected with one pole of the battery via the freewheel diode; and
an output terminal of the control circuit unit is connected to a control terminal of the switching element and a switching frequency of the switching element is controlled by the output signals of the control circuit unit.

4. The battery power supply circuit of claim 3, wherein the switching element is a field effect transistor, a gird of the field effect transistor is connected to the output terminal of the control circuit unit, and the control signal output by the control circuit unit is PWM signal duty ratio of the field effect transistor.

5. The battery power supply circuit of claim 3, wherein a positive pole of the constant current power supply in the main power circuit unit is connected to a positive pole of the battery, a negative pole of the constant current power supply is connected to a negative pole of the battery via the switching element and the energy storage element in turn, a connection point of the switching element and the energy storage element is connected to a positive pole of the freewheel diode, and a negative pole of the freewheel diode is connected to the positive pole of the battery.

6. The battery power supply circuit of claim 1, wherein the control circuit unit comprises a control chip, and an enable pin of the control chip is connected to the constant current power supply, an output terminal of the control chip outputs control signals to the main power circuit unit, an input terminal of the control chip is connected to an output terminal of the constant current feedback circuit unit and an output terminal of the constant voltage feedback circuit unit respectively.

7. The battery power supply circuit of claim 1, wherein the constant current feedback circuit unit comprises a first difference amplifier, a first comparator and a sense resistor connected in series between the main power circuit unit and the battery, two input terminals of the first difference amplifier are connected to two terminals of the sense resistor respectively, an output terminal of the first difference amplifier is connected to one input terminal of the first comparator, another input terminal of the first comparator is connected to a first reference voltage, and an output terminal of the first comparator is connected to an input terminal of the control circuit unit.

8. The battery power supply circuit of claim 7, wherein the sense resistor is connected in series between the main power circuit unit and the cathode of the battery.

9. The battery power supply circuit of claim 1, wherein the constant voltage feedback circuit unit comprises a second difference amplifier and a second comparator, one input terminal of the second difference amplifier is connected to the positive pole of the battery, another input terminal of the second difference amplifier is grounded, an output terminal of the second difference amplifier is connected to an input terminal of the second comparator, another input terminal of the second comparator is connected to a second reference voltage, and an output terminal of the second comparator is connected to the input terminal of the control circuit unit.

10. The battery power supply circuit of claim 1, wherein the first threshold value and the second threshold value are set by a host computer and the host computer is connected to the constant current feedback circuit unit and the constant voltage feedback circuit unit respectively.
